(19) United States
(12) Patent Application Publication
(10) Pub. No.: US 2026/0024672 A1
(43) Pub. Date: Jan. 22, 2026

(54) LOWER-PORTION COMPONENT ATTACHING AND DETACHING APPARATUS AND USE METHOD OF LOWER-PORTION COMPONENT ATTACHING AND DETACHING APPARATUS

(71) Applicant: Hitachi GE Vernova Nuclear Energy, Ltd., Hitachi-shi (JP)

(72) Inventors: Tetsuya TAKADA, Hitachi (JP); Ryosuke FUKADA, Hitachi (JP); Keisuke KURIHARA, Hitachi (JP)

(21) Appl. No.: 19/224,149

(22) Filed: May 30, 2025

(30) Foreign Application Priority Data
Jul. 17, 2024 (JP) 2024-114205

(51) Int. Cl. G21C 7/12

(52) U.S. Cl. CPC G21C 7/12

(57) ABSTRACT

There is provided a lower-portion component attaching and detaching apparatus with which attachment of a spool piece to a main unit of a control rod drive mechanism is easy. A lower-portion component attaching and detaching apparatus includes a raising and lowering mechanism that raises and lowers a spool piece possibly included in a control rod drive mechanism that drives a control rod, by expansion and contraction of a plurality of fluid pressure cylinders, and a pushing-up mechanism that pushes up and holds the spool piece at a height at which attachment of the spool piece to a drive mechanism main unit of the control rod drive mechanism is possible, in a case in which the raising and lowering mechanism is incapable of holding the spool piece at the height at which attachment of the spool piece to the drive mechanism main unit of the control rod drive mechanism is possible.

### CROSS REFERENCE TO RELATED APPLICATION

The present application claims the benefit of priority under 35 U.S.C. § 119 to Japanese Patent Application No. 2024-114205, filed on Jul. 17, 2024, the entire contents of which are incorporated herein by reference in their entirety.

### TECHNICAL FIELD

The present invention relates to a lower-portion component attaching and detaching apparatus including a jig that holds a bottom portion of a spool piece as a lower-portion component located at a lower portion of a drive mechanism main unit in order to attach/detach the spool piece, and a use method of this lower-portion component attaching and detaching apparatus.

### BACKGROUND

In recent years, in an advanced boiling water reactor (ABWR), an electrically-driven fine motion control rod drive mechanism (FMCRD) that includes a drive mechanism main unit, a motor unit, a motor bracket, and a spool piece and enables fine driving of a control rod has been employed.

In periodic inspection of a nuclear reactor, this FMCRD is detached from a lower portion of a reactor pressure vessel for maintenance and check, and is attached to the lower portion of the reactor pressure vessel again.

This attachment/detachment work of the FMCRD is executed at a place where the radiation dose is high, and hence, is required to be executed in a short period of time. To meet this requirement, JP-2023-176419-A (hereinafter referred to as Patent Document 1) discloses a lower-portion component attaching and detaching apparatus for attaching and detaching a motor bracket, a motor unit, and a spool piece that are components located at a lower portion of a drive mechanism main unit.

### BRIEF SUMMARY

The lower-portion component attaching and detaching apparatus of Patent Document 1 raises each of the motor bracket, the motor unit, and the spool piece held by a jig to a position at which attachment/detachment is possible, by a plurality of pneumatic cylinders (multi-stage cylinders). With the pneumatic cylinders, a raising and lowering mechanism becomes more compact than that in a case of using electricity or hydraulic pressure. Thus, the pneumatic cylinders are suitable for use in a narrow environment in which attachment/detachment work of the lower-portion components is executed.

The spool piece among the lower-portion components is a component for positioning a control rod in a control rod drive mechanism. Thus, when the spool piece is attached to the drive mechanism main unit, it is required to hold the spool piece and execute attachment work while supporting a load applied from the control rod to the spool piece by the pneumatic cylinders.

However, the load applied from the control rod to the spool piece includes the water head pressure of cooling water in the pressure vessel, the pressure being applied through the control rod. Thus, the load possibly becomes significantly high compared with a load applied to the motor unit or the motor bracket, and sometimes exceeds the support capability of the pneumatic cylinders. Hence, with the lower-portion component attaching and detaching apparatus of Patent Document 1, when the spool piece is to be attached to the drive mechanism main unit, the plurality of pneumatic cylinders are sometimes incapable of supporting the load applied from the control rod to the spool piece. That is, depending on the load applied to the spool piece, there is a possibility that the pneumatic cylinders cannot hold the spool piece at a height at which attachment of the spool piece to the main unit of the control rod drive mechanism is possible, and that the spool piece cannot be attached to the drive mechanism main unit.

An object of the present invention is to provide a lower-portion component attaching and detaching apparatus in which a plurality of multi-stage cylinders can hold a spool piece at a height at which attachment of the spool piece to a main unit of a control rod drive mechanism is possible, when the spool piece is attached to the drive mechanism main unit.

The present application includes a plurality of measures to solve the above-described problem. As an example thereof, a lower-portion component attaching and detaching apparatus of the present invention includes a raising and lowering mechanism that raises and lowers a spool piece possibly included in a control rod drive mechanism that drives a control rod, by expansion and contraction of a plurality of fluid pressure cylinders, and a pushing-up mechanism that pushes up and holds the spool piece at a height at which attachment of the spool piece to a main unit of the control rod drive mechanism is possible, in a case in which the raising and lowering mechanism is incapable of holding the spool piece at the height.

According to the present invention, even when the plurality of multi-stage cylinders are incapable of pushing up the spool piece to the height at which attachment of the spool piece to the drive mechanism main unit is possible due to the load applied from the control rod, the pushing-up mechanism can push up and hold the spool piece at the height. Thus, attachment of the spool piece to the main unit of the control rod drive mechanism becomes easier. Problems, configurations, and effects other than those described above are made clear by description of the following embodiments.

### BRIEF DESCRIPTION OF THE DRAWINGS

FIG. 1 is a schematic side view depicting a state in which a lower-portion component attaching and detaching apparatus according to a first embodiment of the present invention is incapable of, by a raising and lowering mechanism, pushing up and holding a spool piece as a lower-portion component at a height at which attachment of the spool piece to a main unit of a control rod drive mechanism is possible, and has pushed up the spool piece to the height and holds the spool piece by a pushing-up mechanism;

FIG. 2 is an exploded view of lower-portion components of the control rod drive mechanism;

FIG. 3 is a perspective view of the spool piece;

FIG. 4 is a perspective view of a motor unit;

FIG. 5 is a schematic perspective view depicting a state in which a spool piece holding jig is fixed to the upper ends of a plurality of fluid pressure cylinders contracted and the spool piece holding jig is caused to hold the spool piece in the lower-portion component attaching and detaching apparatus according to the first embodiment of the present invention;

FIG. 6 is an enlarged side view of the spool piece holding jig fixed to the upper ends of the plurality of fluid pressure cylinders contracted in the lower-portion component attaching and detaching apparatus according to the first embodiment and the spool piece held by the spool piece holding jig;

FIG. 7 is a schematic side view depicting a state in which the spool piece has been raised by the raising and lowering mechanism in the lower-portion component attaching and detaching apparatus according to the first embodiment of the present invention;

FIG. 8 is a perspective view of a first jig fixed to the upper ends of two fluid pressure cylinders contracted, a second jig placed on the first jig, and a motor bracket held by the second jig;

FIG. 9 is a perspective view of the first jig fixed to the upper ends of the two fluid pressure cylinders contracted and the motor unit held by the first jig;

FIG. 10 is a schematic perspective view depicting a state in which the raising and lowering mechanism is incapable of holding the spool piece at the height at which attachment of the spool piece to the drive mechanism main unit is possible and the pushing-up mechanism has pushed up the spool piece to the height and holds the spool piece in the lower-portion component attaching and detaching apparatus according to the first embodiment of the present invention;

FIG. 11 is a schematic side view of the pushing-up mechanism in the lower-portion component attaching and detaching apparatus according to the first embodiment of the present invention;

FIG. 12 is a schematic enlarged side view of a pushing-up portion of the pushing-up mechanism in the lower-portion component attaching and detaching apparatus according to the first embodiment of the present invention;

FIG. 13 is a schematic perspective view depicting a state in which the raising and lowering mechanism is incapable of holding the spool piece at the height at which attachment of the spool piece to the drive mechanism main unit is possible and the pushing-up mechanism has pushed up the spool piece to the height and holds the spool piece in a lower-portion component attaching and detaching apparatus according to a second embodiment of the present invention;

FIG. 14 is a side view of a torque wrench installation jig of the lower-portion component attaching and detaching apparatus according to the second embodiment of the present invention; and

FIG. 15 is a perspective view of the torque wrench installation jig of the lower-portion component attaching and detaching apparatus according to the second embodiment of the present invention.

### DETAILED DESCRIPTION

Configurations and operation of lower-portion component attaching and detaching apparatuses according to a first embodiment and a second embodiment of the present invention are described below with use of the drawings.

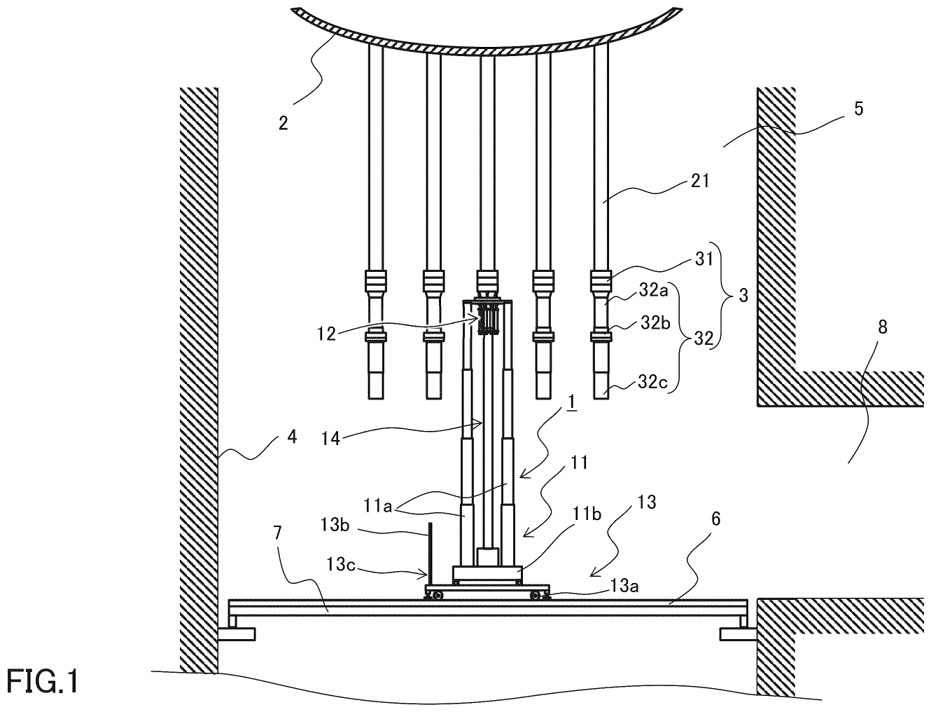

FIG. 1 is a schematic side view depicting a state in which the lower-portion component attaching and detaching apparatus according to the first embodiment of the present invention is incapable of, by a raising and lowering mechanism, pushing up and holding a spool piece as a lower-portion component at a height at which attachment of the spool piece to a main unit of a control rod drive mechanism is possible, and has pushed up the spool piece to the height and holds the spool piece by a pushing-up mechanism.

A lower-portion component attaching and detaching apparatus 1 is an apparatus that attaches and detaches lower-portion components 32 of a control rod drive mechanism 3 disposed under a reactor pressure vessel 2. Details thereof are described later.

The reactor pressure vessel 2 under which the control rod drive mechanism 3 is disposed is a circular cylindrical steel structure that houses a fuel assembly, and is disposed, for example, over a pedestal space 5 that is a circular cylindrical space surrounded by a pedestal 4.

The pedestal 4 is a foundation that supports a reactor main body in a reactor containment vessel of an advanced boiling water reactor. A plurality of control rod housings 21 protrude downward under the reactor pressure vessel 2.

The control rod drive mechanism 3 is a device that pulls out and inserts a control rod disposed at the center of the fuel assembly from and into a reactor core to control nuclear fission. The control rod drive mechanism 3 normally pulls out and inserts the control rod from and into the reactor core by power of a motor unit 32c to be described later. Meanwhile, in case of abnormality, the control rod drive mechanism 3 inserts the control rod into the reactor core at once by water pressure.

The control rod drive mechanism 3 includes a drive mechanism main unit 31 that is a main unit of the control rod drive mechanism and the lower-portion components 32.

The drive mechanism main unit 31 is a component that grasps and moves the control rod and is housed in the control rod housing 21. The lower end of the drive mechanism main unit 31 is fastened to a lower portion of the control rod housing 21 by flange fastening.

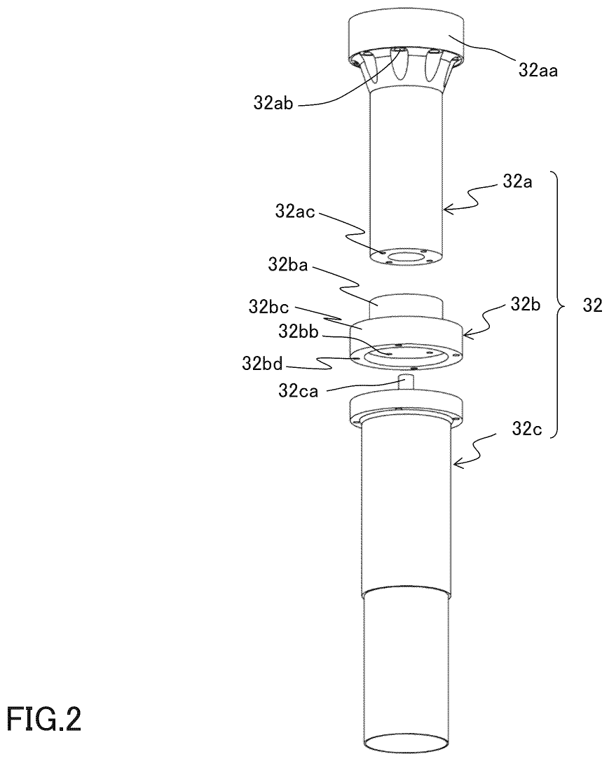

The lower-portion components 32 are a plurality of components disposed under the drive mechanism main unit 31. FIG. 2 is an exploded view of the lower-portion components 32 of the control rod drive mechanism 3. As depicted in FIG. 2, the lower-portion components 32 include a spool piece 32a, a motor bracket 32b, and the motor unit 32c.

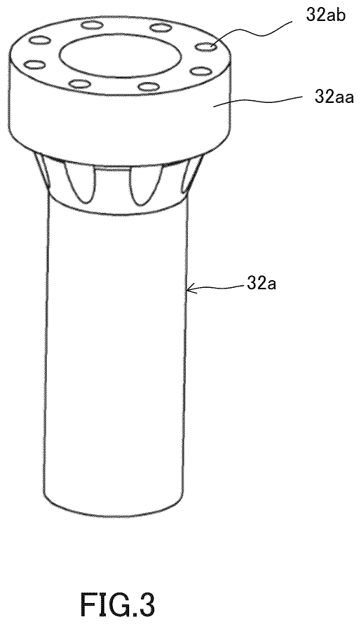

FIG. 3 is a perspective view of the spool piece 32a. The spool piece 32a is a component that transmits a rotational force generated by the motor unit 32c to the drive mechanism main unit 31 and positions the control rod. As depicted in FIG. 3, a flange portion 32aa is disposed at the upper end of the spool piece 32a. Further, in the flange portion 32aa, a plurality of (in the present embodiment, eight) through-holes 32ab that vertically penetrate the flange portion 32aa are defined.

Joining parts (bolts are preferable) are inserted into the plurality of through-holes 32ab from the lower side, and are screwed into bolt holes (not depicted) defined in a lower surface of a flange of the drive mechanism main unit 31. This joins the spool piece 32a to the drive mechanism main unit 31.

As depicted in FIG. 2, the motor bracket 32b is a circular cylindrical component that connects the spool piece 32a to the motor unit 32c, and has a motor bracket main body 32ba and a flange portion 32bc. A through-hole (not depicted) for insertion of a shaft 32ca protruding from the motor unit 32c is defined at the center of the motor bracket main body 32ba. Moreover, in the motor bracket main body 32ba, a plurality of through-holes 32bb that vertically penetrate the motor bracket main body 32ba are defined. A plurality of bolt holes 32bd are defined in a lower surface of the flange portion 32bc.

Joining parts (bolts are preferable) are inserted into the plurality of through-holes 32bb of the motor bracket main body 32ba from the lower side, and are screwed into bolt holes 32ac defined in a lower surface of the spool piece 32a. This joins the motor bracket 32b to the spool piece 32a.

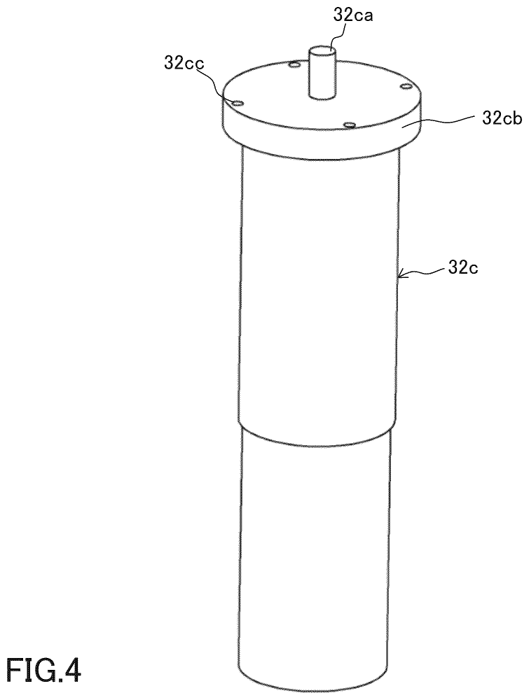

FIG. 4 is a perspective view of the motor unit 32c. The motor unit 32c is a component having therein an electric motor as a drive source, and the shaft 32ca that is an output shaft protrudes from an upper end surface thereof as depicted in FIG. 4. A flange portion 32cb is disposed at an upper portion of the motor unit 32c. In the flange portion 32cb, a plurality of through-holes 32cc that vertically penetrate the flange portion 32cb are defined.

A joining part (bolt is preferable) is inserted into each of the plurality of through-holes 32cc from the lower side, and is screwed into any of the plurality of bolt holes 32bd defined in the lower surface of the flange portion 32bc of the motor bracket 32b. This joins the motor unit 32c to the motor bracket 32b.

As depicted in FIG. 1, a rail 6 that supports movement of the lower-portion component attaching and detaching apparatus 1 is disposed under the lower-portion component attaching and detaching apparatus 1. Further, a platform 7 that can rotate around an axis along a vertical direction by remote operation is disposed under the rail 6.

The lower-portion component attaching and detaching apparatus 1 includes a raising and lowering mechanism 11 that raises and lowers the spool piece 32a possibly included in the control rod drive mechanism 3 that drives the control rod, by expansion and contraction of a plurality of fluid pressure cylinders.

As depicted in FIG. 1, the raising and lowering mechanism 11 includes a plurality of (in the present embodiment, two) fluid pressure cylinders 11a and a support plate 11b that supports the plurality of fluid pressure cylinders 11a.

The fluid pressure cylinders 11a are devices that convert the pressure of a fluid to a mechanical force to expand and contract in the vertical direction. The expansion and contraction of the fluid pressure cylinders 11a in the present embodiment are executed directly below the reactor pressure vessel 2 and are used for work requiring positional accuracy. Thus, it is preferable that the fluid pressure cylinders 11a be water pressure cylinders.

Further, the lower-portion components 32 are disposed at a high place, and check thereof is executed after they are lowered from the high place to a low place. Thus, it is preferable that the stroke of the fluid pressure cylinders 11a be long. For this reason, it is preferable that the fluid pressure cylinders 11a be multi-stage cylinders.

The support plate 11b is a plate-shaped member to which lower portions of the plurality of fluid pressure cylinders 11a are fixed and that supports the plurality of fluid pressure cylinders 11a standing along the vertical direction. The support plate 11b is allowed to slide and rotate by a slide table 13e and a rotation table 13f to be described later.

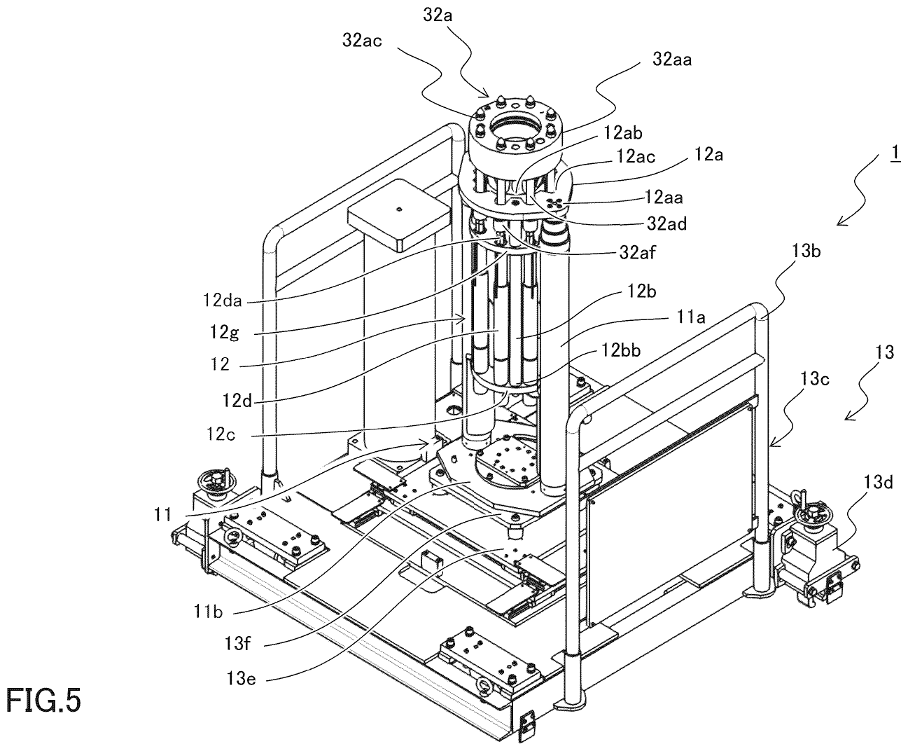

FIG. 5 is a schematic perspective view depicting a state in which a spool piece holding jig 12 is fixed to the upper ends of the plurality of fluid pressure cylinders 11a contracted and the spool piece holding jig 12 is caused to hold the spool piece 32a in the lower-portion component attaching and detaching apparatus 1 according to the present embodiment.

As depicted in FIG. 5, it is preferable that the spool piece holding jig 12 be fixed to the upper ends of the plurality of fluid pressure cylinders 11a.

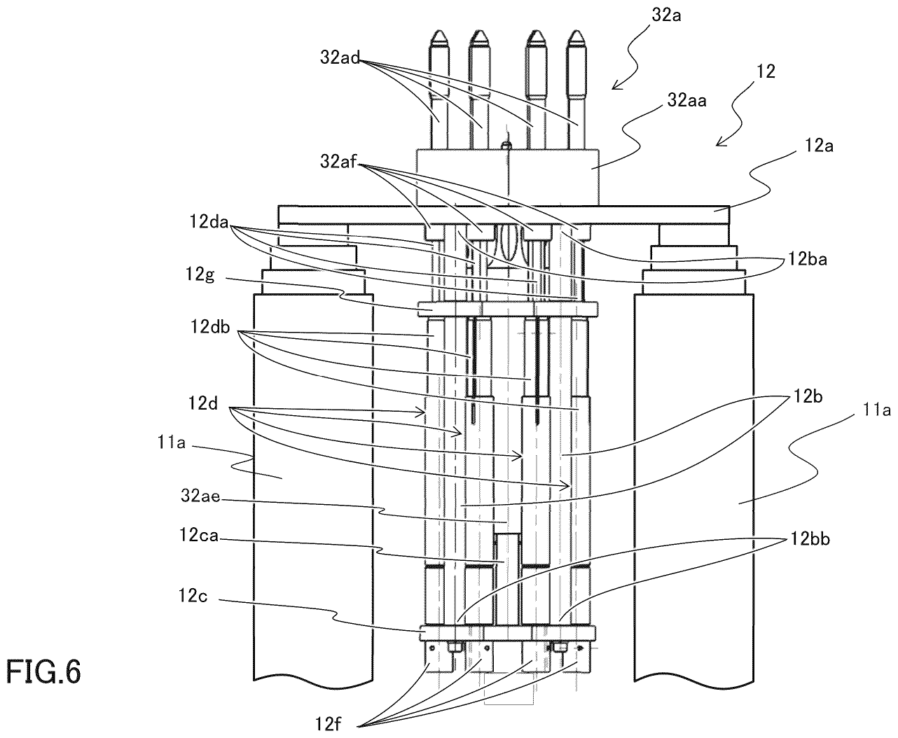

FIG. 6 is an enlarged side view of the spool piece holding jig 12 fixed to the upper ends of the plurality of fluid pressure cylinders 11a contracted in the lower-portion component attaching and detaching apparatus 1 according to the present embodiment and the spool piece 32a held by the spool piece holding jig 12.

The spool piece holding jig 12 is a jig that holds the spool piece 32a among the lower-portion components 32. It is preferable for the spool piece holding jig 12 to have an upper plate 12a, a lower plate 12c, and a plurality of bolt wrenches 12d as depicted in FIGS. 5 and 6. The upper plate 12a is joined to an upper portion of the raising and lowering mechanism 11 (two fluid pressure cylinders 11a) and has a hole 12ab into which the spool piece 32a is inserted. The lower plate 12c is disposed under the upper plate 12a, is joined to the upper plate 12a with a plurality of rod-shaped members 12b interposed therebetween, and supports the spool piece 32a. The plurality of bolt wrenches 12d are attached to the lower plate 12c rotatably in a circumferential direction and fasten and loosen each of a plurality of bolts 32ad that join the spool piece 32a to the drive mechanism main unit 31. It is preferable that the number of bolts 32ad and the number of bolt wrenches 12d be the same as the number of through-holes 32ab defined in the flange portion 32aa of the spool piece 32a. In the present embodiment, the number is eight.

It is preferable for the upper plate 12a to be a plate-shaped member fixed to the upper ends of the fluid pressure cylinders 11a by, for example, bolts and be a circular plate in which fixed portions 12aa (see FIG. 5) fixed by the bolts protrude outward in a radial direction. Further, it is preferable that the hole 12ab into which the spool piece 32a is inserted be defined at the center of the upper plate 12a as depicted in FIG. 5.

The plurality of rod-shaped members 12b are components that couple the upper plate 12a to the lower plate 12c and have a rod shape.

The lower plate 12c is a plate-shaped member joined to the upper plate 12a with the plurality of rod-shaped members 12b interposed therebetween, and supports the spool piece 32a inserted from the hole 12ab of the upper plate 12a.

It is preferable that a support rod 12ca (see FIG. 6) that fits into a hole in a bottom portion 32ac (see FIG. 6) of the spool piece 32a to suppress movement and fall of the spool piece 32a and supports the spool piece 32a be disposed on an upper surface of the lower plate 12c.

Moreover, the plurality of bolt wrenches 12d are parts for fastening and loosening the plurality of bolts 32ad that are inserted into the plurality of through-holes 32ab of the flange portion 32aa of the spool piece 32a from the lower side and are screwed into the plurality of bolt holes in the flange portion of the drive mechanism main unit 31 to join the spool piece 32a to the drive mechanism main unit 31.

It is preferable that each of the plurality of bolt wrenches 12d be attached to the lower plate 12c rotatably in the circumferential direction.

In the present embodiment, the plurality of bolts 32ad are bolts with a hexagonal hole, and the upper end of each of the plurality of bolt wrenches 12d is a hexagonal wrench 12da inserted into a respective one of the hexagonal holes defined in heads 32af of the plurality of bolts 32ad.

Further, it is preferable that main bodies 12db of the plurality of bolt wrenches 12d be each formed of a circular rod covered by a pipe. This can ensure strength performance and safety performance.

The lower ends of the circular rods forming the main bodies 12db of the plurality of bolt wrenches 12d are attached to the lower plate 12c rotatably in a circumferential direction of each of the plurality of bolt wrenches 12d. Meanwhile, it is preferable that lower portions of the pipes that form the main bodies 12db of the plurality of bolt wrenches 12d and cover the circular rod be fixed to the lower plate 12c.

Moreover, the upper ends of the circular rods forming the main bodies 12db of the plurality of bolt wrenches 12d are attached to an intermediate plate 12g rotatably in the circumferential direction of each of the plurality of bolt wrenches 12d. Meanwhile, it is preferable that the upper ends of the pipes that form the main bodies 12db of the plurality of bolt wrenches 12d and cover the circular rod be fixed to the intermediate plate 12g.

The intermediate plate 12g is a plate disposed between the upper plate 12a and the lower plate 12c. In the intermediate plate 12g, through-holes for allowing the plurality of rod-shaped members 12b to pass therethrough and a hole for insertion of the spool piece 32a are defined. Due to this, each of the plurality of bolt wrenches 12d is inhibited from moving in upward-downward, left-right, and front-rear directions and rotates only in the circumferential direction in the spool piece holding jig 12.

Further, a plurality of through-holes 12ac (see FIG. 5; in the present embodiment, the through-holes 12ac communicate with the through-hole for insertion of the spool piece 32a) with a diameter larger than the outer diameter of the heads 32af of the plurality of bolts 32ad are defined in the upper plate 12a such that the heads 32af can pass through the through-holes 12ac.

Moreover, as depicted in FIG. 6, in the spool piece holding jig 12 according to the present embodiment, a plurality of sockets 12f that are coupled to any of the plurality of bolt wrenches 12d and rotate the coupled bolt wrench 12d in the circumferential direction may be disposed under the lower plate 12c.

Due to this, with the spool piece holding jig 12, hexagonal wrenches can be inserted into hexagonal holes defined in the plurality of sockets 12f, and the plurality of bolts 32ad can be fastened into the bolt holes defined in the lower surface of the flange of the drive mechanism main unit 31.

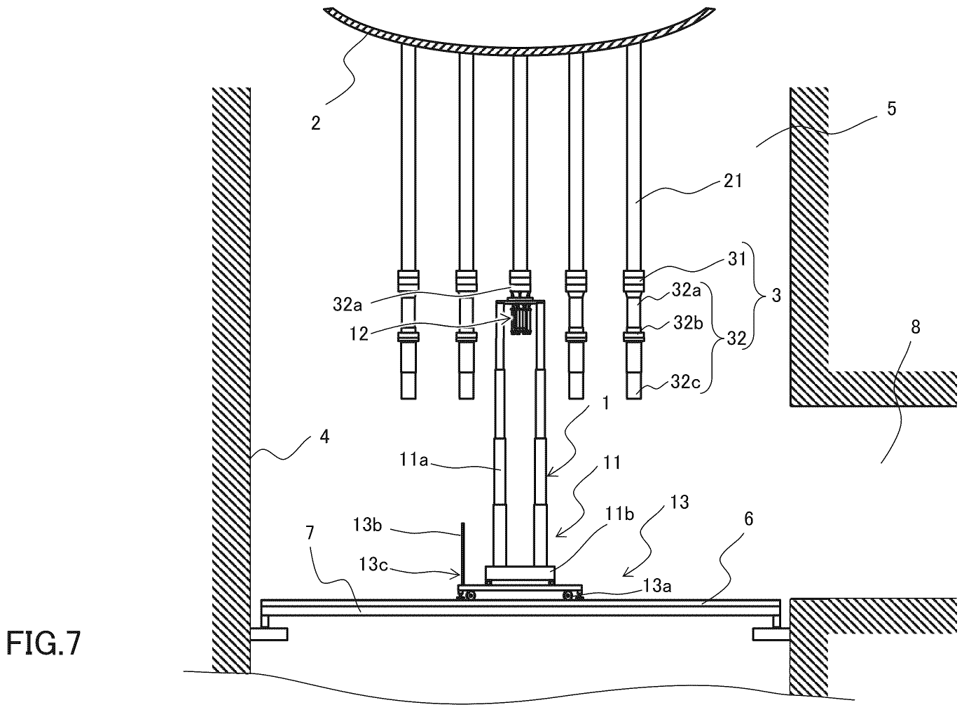

FIG. 7 is a schematic side view depicting a state in which the spool piece 32a has been raised by the raising and lowering mechanism 11 in the lower-portion component attaching and detaching apparatus 1 according to the present embodiment.

The spool piece 32a held by the spool piece holding jig 12 fixed to the upper ends of the plurality of fluid pressure cylinders 11a of the lower-portion component attaching and detaching apparatus 1 is raised by expansion of the plurality of fluid pressure cylinders 11a as depicted in FIG. 7.

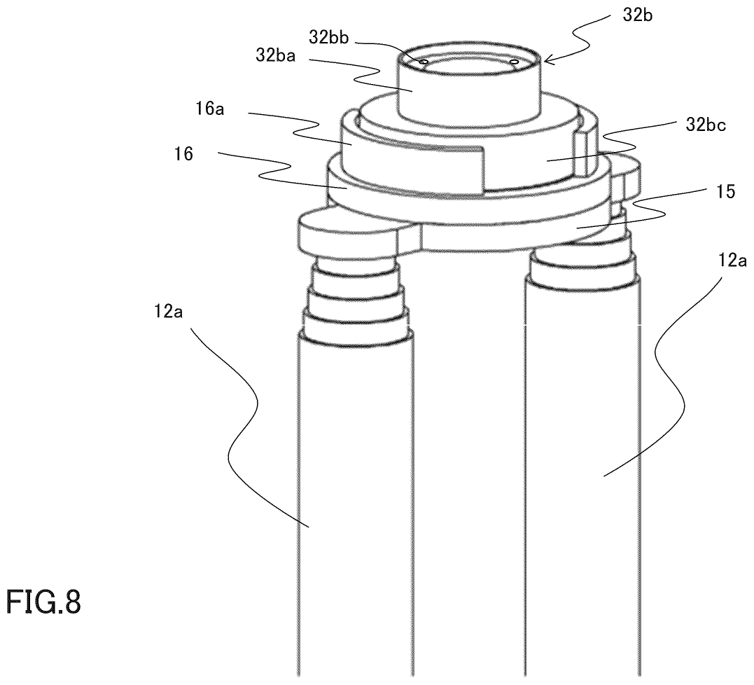

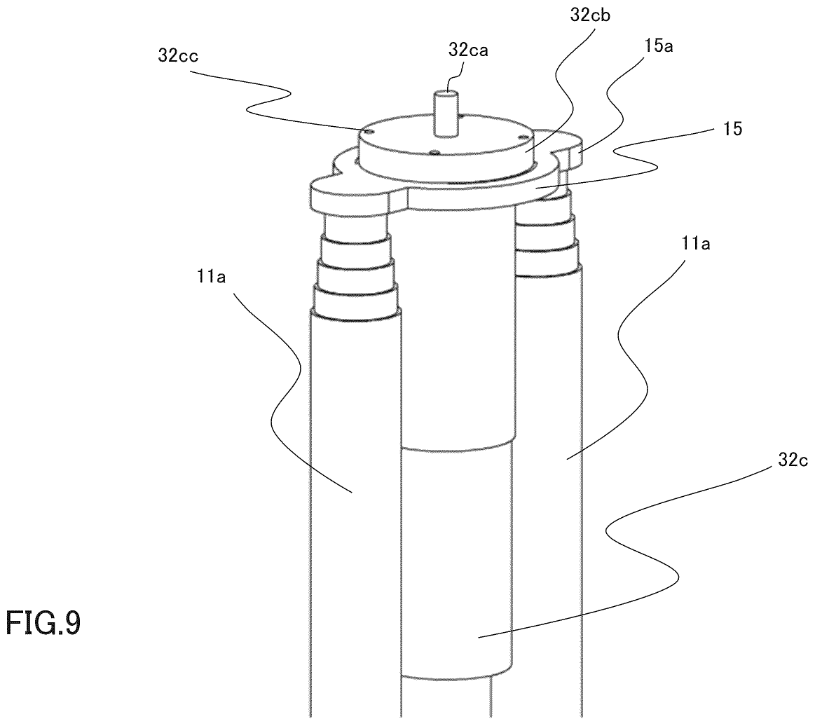

FIG. 8 is a perspective view of a first jig 15 fixed to the upper ends of the two fluid pressure cylinders 11a contracted, a second jig 16 placed on the first jig 15, and the motor bracket 32b held by the second jig 16. FIG. 9 is a perspective view of the first jig 15 fixed to the upper ends of the two fluid pressure cylinders 11a contracted and the motor unit 32c held by the first jig 15.

The spool piece holding jig 12 can be detached from the upper ends of the fluid pressure cylinders 11a by detaching the bolts of the fixed portions 12aa (see FIG. 5). Thus, after the spool piece 32a is attached to the drive mechanism main unit 31, the plurality of fluid pressure cylinders 11a are contracted, and the spool piece holding jig 12 is detached from the upper ends of the plurality of fluid pressure cylinders 11a.

Thereafter, as depicted in FIG. 8, the first jig 15 is attached to the upper ends of the plurality of fluid pressure cylinders 11a, and the second jig 16 is placed on the first jig 15. Then, the second jig 16 is caused to hold the motor bracket 32b. Then, the second jig 16 that holds the motor bracket 32b is raised by expanding the plurality of fluid pressure cylinders 11a. This can join the motor bracket 32b to the spool piece 32a joined to the drive mechanism main unit 31.

Moreover, after the motor bracket 32b is joined to the spool piece 32a, the plurality of fluid pressure cylinders 11a are contracted, and the second jig 16 is detached from the first jig 15. Then, as depicted in FIG. 9, the first jig 15 is caused to hold the motor unit 32c. Then, the first jig 15 that holds the motor unit 32c is raised by expanding the plurality of fluid pressure cylinders 11a. This can join the motor unit 32c to the motor bracket 32b joined to the spool piece 32a.

Further, conversely, after the motor unit 32c is detached from the motor bracket 32b by using the first jig 15, the second jig 16 is placed on the first jig 15 as depicted in FIG. 8. This can hold the motor bracket 32b by the second jig 16 and detach the motor bracket 32b from the spool piece 32a.

Moreover, after the motor bracket 32b is detached from the spool piece 32a, the second jig 16 is detached from the first jig 15, and the first jig 15 is detached from the upper ends of the plurality of fluid pressure cylinders 11a. Thereafter, the spool piece holding jig 12 is attached to the upper ends of the fluid pressure cylinders 11a. This can hold the spool piece 32a by the spool piece holding jig 12 and detach the spool piece 32a from the drive mechanism main unit 31.

Therefore, the lower-portion component attaching and detaching apparatus 1 can attach and detach each of the spool piece 32a, the motor bracket 32b, and the motor unit 32c configuring the lower-portion components 32 to and from the control rod drive mechanism 3.

It is preferable for the lower-portion component attaching and detaching apparatus 1 to have a movement mechanism 13 that allows the lower-portion component attaching and detaching apparatus 1 to move over the platform 7 below the reactor pressure vessel 2 as depicted in FIGS. 1, 5, and 7.

As depicted in FIGS. 1, 5, and 7, the movement mechanism 13 may include a carriage 13c having flanged wheels 13a that can move by human power along the rail 6 laid on the platform 7 and a grip portion 13b to be gripped by a worker to move the lower-portion component attaching and detaching apparatus 1. It is preferable that the carriage 13c be provided with a stopper 13d (see FIG. 5) that fixes the carriage 13c moved to the lower side of the lower-portion components 32.

Moreover, it is preferable for the movement mechanism 13 to be provided with at least one of the slide table 13e that can slide the support plate 11b of the raising and lowering mechanism 11 along a surface of the support plate 11b and allow positioning of the support plate 11b and the rotation table 13f that can rotate the support plate 11b around an axis along the vertical direction and allow positioning of the support plate 11b concerning the rotation angle thereof.

In the present embodiment, the slide table 13e is fixed onto the carriage 13c, and the rotation table 13f is fixed onto the slide table 13c. In addition, the support plate 11b is fixed onto the rotation table 13f.

Further, it is preferable for the slide table 13e to include a stopper (not depicted) for positioning the slid table, and it is preferable for the rotation table 13f to include a stopper (not depicted) for positioning the rotated table concerning the rotation angle thereof.

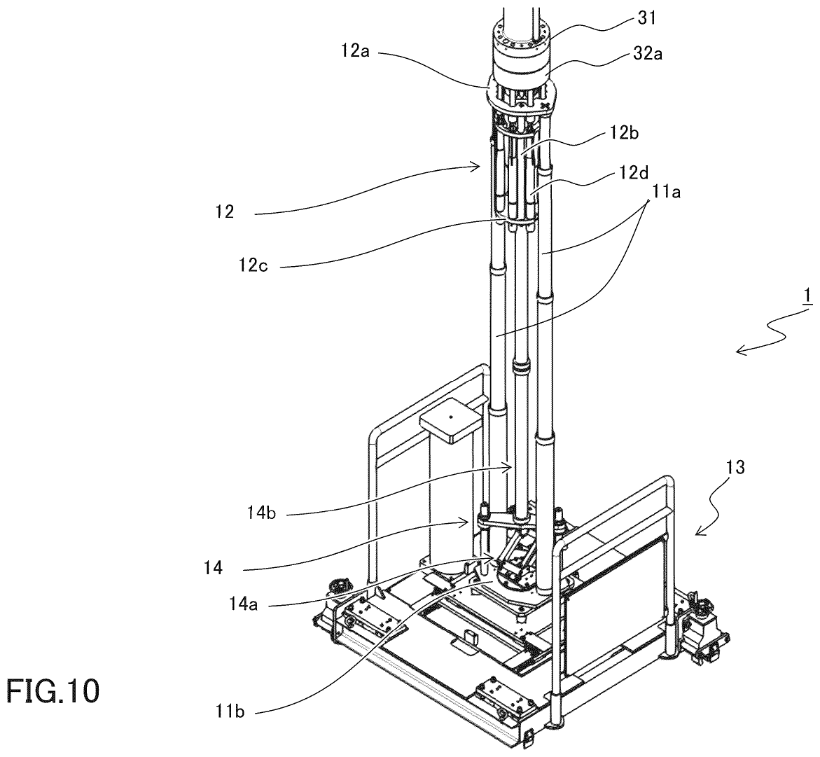

FIG. 10 is a schematic perspective view depicting a state in which the raising and lowering mechanism 11 is incapable of holding the spool piece 32a at a height at which attachment of the spool piece 32a to the drive mechanism main unit 31 is possible and a pushing-up mechanism 14 has pushed up the spool piece 32a to the height and holds the spool piece 32a in the lower-portion component attaching and detaching apparatus 1 according to the present embodiment.

The pushing-up mechanism 14 is a mechanism for pushing up and holding the spool piece 32a at a height at which attachment of the spool piece 32a to the drive mechanism main unit 31 is possible, through the lower plate 12c of the spool piece holding jig 12, in a case in which the raising and lowering mechanism 11 is incapable of raising and holding the spool piece 32a at the height at which attachment of the spool piece 32a to the drive mechanism main unit 31 is possible.

To attach the spool piece 32a to the drive mechanism main unit 31, the spool piece 32a is required to be raised and held at a height at which an upper surface of the flange portion 32aa of the spool piece 32a makes surface contact with the lower surface of the flange portion of the drive mechanism main unit 31 (height at which attachment of the spool piece 32a to the drive mechanism main unit 31 is possible).

However, a load including the water head pressure of cooling water in the reactor pressure vessel 2 is applied to the spool piece 32a through the control rod. Thus, the load sometimes becomes significantly high compared with a load applied to the motor unit or the motor bracket.

In such a case, it becomes difficult for the raising and lowering mechanism 11 to raise and hold the spool piece 32a at the height at which the upper surface of the flange portion 32aa of the spool piece 32a makes surface contact with the lower surface of the flange portion of the drive mechanism main unit 31.

The lower-portion component attaching and detaching apparatus 1 includes the pushing-up mechanism 14 that, in such a case, pushes up and holds the spool piece 32a at a height at which attachment of the spool piece 32a to the drive mechanism main unit 31 is possible.

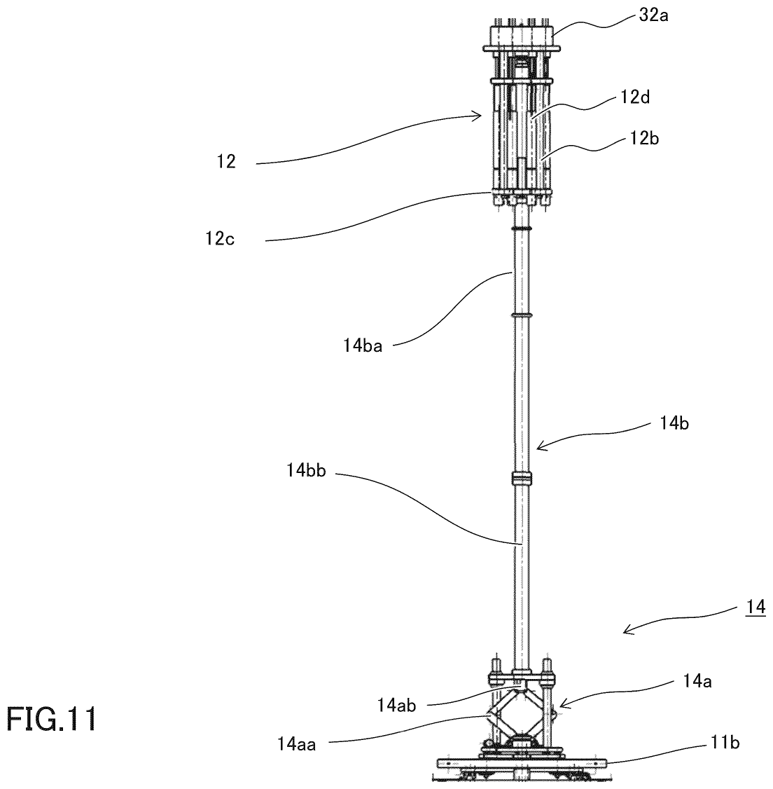

FIG. 11 is a schematic side view of the pushing-up mechanism 14 in the lower-portion component attaching and detaching apparatus 1 according to the present embodiment. As depicted in FIG. 11, the pushing-up mechanism 14 has a pushing-up portion 14a and a prop portion 14b.

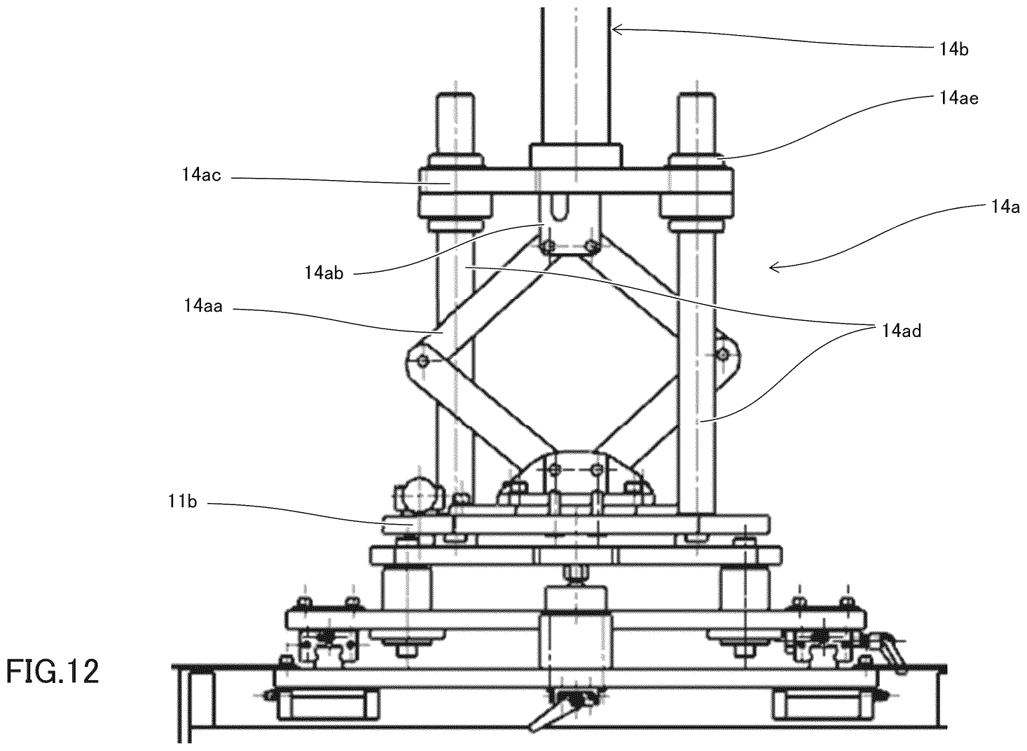

FIG. 12 is a schematic enlarged side view of the pushing-up portion 14a of the pushing-up mechanism 14 in the lower-portion component attaching and detaching apparatus 1 according to the present embodiment.

It is preferable that the pushing-up portion 14a include a mechanical jack 14aa and that a load receiving portion 14ab of the mechanical jack 14aa push up and hold the spool piece 32a at a height at which attachment of the spool piece 32a to the drive mechanism main unit 31 is possible, through the prop portion 14b.

It is preferable that the mechanical jack 14aa be what is generally called a pantograph-type jack. The mechanical jack 14aa is placed on the support plate 11b of the raising and lowering mechanism 11 and can vertically move the load receiving portion 14ab through operation of a handle that is not depicted.

The pushing-up portion 14a further has a driven plate 14ac that moves in such a manner as to follow the vertical motion of the load receiving portion 14ab of the mechanical jack 14aa, and a plurality of (in the present embodiment, two) pins 14ad that support the vertical motion of the driven plate 14ac.

The driven plate 14ac is a plate-shaped member having a lower surface in contact with an upper portion of the load receiving portion 14ab and an upper surface on which a lower portion of the prop portion 14b is placed. A plurality of through-holes that vertically penetrate the driven plate 14ac and into which the plurality of pins 14ad are inserted are defined in the driven plate 14ac. Bushes 14ac are attached to the plurality of through-holes such that inner circumferential surfaces of the plurality of through-holes may slide on side surfaces of the plurality of pins 14ad.

It is preferable that the plurality of positioning pins 14ad be circular column bodies that have lower ends fixed to the support plate 11b and extend upward, and that upper ends thereof be located at a position higher than the highest position of the load receiving portion 14ab of the mechanical jack 14aa.

These configurations allow the driven plate 14ac to rise along the plurality of pins 14ad according to a rise of the load receiving portion 14ab of the mechanical jack 14aa and stably push up the lower portion of the prop portion 14b.

It is also possible to dispose a mechanism that causes attachment and detachment between the upper surface of the driven plate 14ac and the lower portion of the prop portion 14b such that the lower portion of the prop portion 14b can be attached and detached to and from the upper surface of the driven plate 14ac.

It is preferable that, as depicted in FIG. 11, the prop portion 14b be an elongated support rod that is disposed over the load receiving portion 14ab of the mechanical jack 14aa and supports the load of the spool piece 32a. Further, it is preferable that the prop portion 14b that is the elongated support rod be formed by disposing a plurality of rod materials (in the present embodiment, two rod materials 14ba and 14bb) in series in its axial direction.

It is preferable to attach the highest rod material (in the present embodiment, rod material 14ba) among the plurality of rod materials forming the prop portion 14b to a lower surface of the lower plate 12c of the spool piece holding jig 12. Moreover, it is preferable to attach the lowest rod material (in the present embodiment, rod material 14bb) among the plurality of rod materials forming the prop portion 14b to the upper surface of the driven plate 14ac of the pushing-up portion 14a.

In the present embodiment, the plurality of rod materials are the two rod materials 14ba and 14bb, and another rod material is not attached to the lower end of the highest rod material 14ba. However, when the plurality of rod materials are three or more rod materials, it is preferable to dispose a rod material other than the lowest rod material in series in the axial direction and attach this rod material to the lower end of the highest rod material 14ba, thereby forming an upper rod material.

It is preferable that a space exist between the lower end of the upper rod material (in the present embodiment, rod material 14ba) and the upper end of the lowest rod material (in the present embodiment, rod material 14bb) before the load receiving portion 14ab of the mechanical jack 14aa is pushed up. This can make attachment of the prop portion 14b easier.

Further, it is preferable that the shape of the lower end of the upper rod material (in the present embodiment, rod material 14ba) and the upper end of the lowest rod material (in the present embodiment, rod material 14bb) be a flat surface. Due to this, when the load receiving portion 14ab of the mechanical jack 14aa is pushed up, the lower end of the upper rod material (in the present embodiment, rod material 14ba) makes surface contact with the upper end of the lowest rod material (in the present embodiment, rod material 14bb). Thus, buckling of the prop portion 14b can be suppressed.

Each of the lower end of the upper rod material (in the present embodiment, rod material 14ba) and the upper end of the lowest rod material (in the present embodiment, rod material 14bb) may be provided with a flange. In this case, after the lower end of the upper rod material (in the present embodiment, rod material 14ba) makes contact with the upper end of the lowest rod material (in the present embodiment, rod material 14bb), these lower and upper ends may be joined by a bolt. This can improve the safety.

The plurality of rod materials (in the present embodiment, two rod materials 14ba and 14bb) may be formed of a pipe that can withstand the load applied from the spool piece 32a.

(Use Method of Lower-portion Component Attaching and Detaching Apparatus 1)

Next, a use method of the lower-portion component attaching and detaching apparatus 1 according to the present embodiment is described.

First, the bolts 32ad are inserted from the lower side into the respective through-holes 32ab of the spool piece 32a for which maintenance and check have been executed in a repair room 8, and are temporarily fixed so as not to drop.

Subsequently, the spool piece 32a is hoisted by a crane or the like to be positioned above the spool piece holding jig 12 fixed to the upper ends of the plurality of fluid pressure cylinders 11a contracted in the lower-portion component attaching and detaching apparatus 1.

Next, the spool piece 32a is lowered such that the bottom portion 32ae of the spool piece 32a passes through the hole 12ab of the upper plate 12a and the hole of the intermediate plate 12g in the spool piece holding jig 12.

Subsequently, the spool piece 32a is further lowered such that the upper ends of the hexagonal wrenches 12da of the plurality of bolt wrenches 12d included in the spool piece holding jig 12 are inserted into the respective hexagonal holes defined in the heads 32af of the plurality of bolts 32ad.

Next, the spool piece 32a is further lowered until the bottom portion 32ae of the spool piece 32a fits to the support rod 12ca disposed on the upper surface of the lower plate 12c. Then, the spool piece 32a is detached from the crane or the like after it is confirmed that the spool piece 32a has been supported by the lower plate 12c.

Subsequently, the lower-portion component attaching and detaching apparatus 1 is moved onto the rail 6 of the platform 7, and the platform 7 is turned by remote operation to cause the rail 6 to pass below the drive mechanism main unit 31 to which the spool piece 32a is to be attached.

Next, the lower-portion component attaching and detaching apparatus 1 is moved along the rail 6 by human power to a position directly below the drive mechanism main unit 31 to which the spool piece 32a is to be attached, and the carriage 13c is fixed by the stopper 13d.

Subsequently, water is injected into the plurality of fluid pressure cylinders 11a by an operation device included in the lower-portion component attaching and detaching apparatus 1, and the plurality of fluid pressure cylinders 11a are expanded to raise the spool piece 32a.

At this time, the spool piece 32a is raised to a height at which the upper surface of the flange portion 32aa of the spool piece 32a makes surface contact with the lower surface of the flange portion of the drive mechanism main unit 31, without causing the spool piece holding jig 12 to interfere with the control rod drive mechanism 3 in the surroundings.

In a case in which the raising and lowering mechanism 11 is incapable of raising and holding the spool piece 32a at the height at which the upper surface of the flange portion 32aa of the spool piece 32a makes surface contact with the lower surface of the flange portion of the drive mechanism main unit 31, the pushing-up mechanism 14 is attached below the spool piece 32a.

Next, the spool piece 32a is pushed up and held by the pushing-up mechanism 14 at the height at which the upper surface of the flange portion 32aa of the spool piece 32a makes surface contact with the lower surface of the flange portion of the drive mechanism main unit 31.

Subsequently, the spool piece 32a is attached to the drive mechanism main unit 31 by the following steps.

On the other hand, in a case in which it is determined that the raising and lowering mechanism 11 is capable of raising and holding the spool piece 32a at the height at which the upper surface of the flange portion 32aa of the spool piece 32a makes surface contact with the lower surface of the flange portion of the drive mechanism main unit 31, processing is advanced to the following steps without attaching the pushing-up mechanism 14 below the spool piece 32a.

Next, fine adjustment of the position and orientation of the fluid pressure cylinders 11a is executed by the slide table 13e and the rotation table 13f to allow the plurality of bolts 32ad to be attached to the respective bolt holes (not depicted) defined in the lower surface of the drive mechanism main unit 31.

Subsequently, hexagonal wrenches are attached to the plurality of sockets 12f, and the plurality of bolt wrenches 12d are rotated to fasten the plurality of bolts 32ad into the plurality of bolt holes in the lower surface of the drive mechanism main unit 31 and join the spool piece 32a to the drive mechanism main unit 31.

The lower-portion component attaching and detaching apparatus 1 of the present embodiment includes the raising and lowering mechanism 11 that raises and lowers the spool piece 32a possibly included in the control rod drive mechanism 3 that drives the control rod, by expansion and contraction of the plurality of fluid pressure cylinders 11a, and the pushing-up mechanism 14 that pushes up and holds the spool piece 32a at a height at which attachment of the spool piece 32a to the drive mechanism main unit 31 of the control rod drive mechanism 3 is possible, in a case in which the raising and lowering mechanism 11 is incapable of holding the spool piece 32a at the height at which attachment of the spool piece 32a to the drive mechanism main unit 31 of the control rod drive mechanism 3 is possible.

Due to this, even when a load exceeding the pushing-up capability that the fluid pressure cylinders 11a of the raising and lowering mechanism 11 have is acting on the spool piece 32a, the spool piece 32a can be pushed up by the pushing-up mechanism 14 to the height at which attachment of the spool piece 32a to the drive mechanism main unit 31 of the control rod drive mechanism 3 is possible. Thus, the attachment of the spool piece 32a to the drive mechanism main unit 31 of the control rod drive mechanism 3 becomes easier.

Further, it is preferable that the pushing-up mechanism 14 of the lower-portion component attaching and detaching apparatus 1 of the present embodiment include the mechanical jack 14aa and that the load receiving portion 14ab of the mechanical jack 14aa push up and hold the spool piece 32a at the height at which attachment of the spool piece 32a to the drive mechanism main unit 31 of the control rod drive mechanism 3 is possible.

Due to this, the cost can be reduced. In addition, the occurrence of a contingency such as a fire can be suppressed as compared with a case of using a hydraulic jack or an electric jack.

Moreover, it is preferable that the pushing-up mechanism 14 of the lower-portion component attaching and detaching apparatus 1 of the present embodiment include the support rod (prop portion 14b) that supports the load of the spool piece 32a over the load receiving portion 14ab of the mechanical jack 14aa, and that the support rod (prop portion 14b) be formed by disposing the plurality of rod materials (in the present embodiment, two rod materials 14ba and 14bb) in series in the axial direction.

Due to this, the load of the spool piece 32a is supported by the support rod (prop portion 14b) with a simple shape, and thus the cost can be reduced. Further, the plurality of rod materials (in the present embodiment, two rod materials 14ba and 14bb) can be easily carried in to a work place, and installation of the pushing-up mechanism 14 can be made easier.

Further, it is preferable that each of the plurality of fluid pressure cylinders 11a of the raising and lowering mechanism 11 of the lower-portion component attaching and detaching apparatus 1 of the present embodiment be a multi-stage cylinder. This can make the stroke longer. Thus, the spool piece 32a can be positioned to a high position from a low position compared with a single-stage cylinder.

Moreover, it is preferable that the fluid pressure cylinders 11a of the raising and lowering mechanism 11 of the lower-portion component attaching and detaching apparatus 1 of the present embodiment be water pressure cylinders. This can improve response performance and positional accuracy compared with a pneumatic cylinder. In addition, because the water pressure is used, the occurrence of a contingency such as a fire can be suppressed compared with a hydraulic or electrical system.

Further, it is preferable for the spool piece holding jig 12 of the lower-portion component attaching and detaching apparatus 1 of the present embodiment to have the upper plate 12a that is joined to the upper portion of the raising and lowering mechanism 11 and has the hole 12ab into which the spool piece 32a is inserted, the lower plate 12c that is disposed under the upper plate 12a, is joined to the upper plate 12a with the plurality of rod-shaped members 12b interposed therebetween, and supports the spool piece 32a, and the plurality of bolt wrenches 12d that are attached to the lower plate 12c rotatably in the circumferential direction and fasten and loosen each of the plurality of bolts 32ad that fix the spool piece 32a to the drive mechanism main unit 31 of the control rod drive mechanism 3. This can efficiently attach and detach the spool piece 32a to and from the drive mechanism main unit 31.

Moreover, the use method of the lower-portion component attaching and detaching apparatus 1 according to the present embodiment is a use method of the lower-portion component attaching and detaching apparatus 1 for attaching and detaching the spool piece 32a possibly included in the control rod drive mechanism 3 that drives the control rod to and from the drive mechanism main unit 31 of the control rod drive mechanism 3. The lower-portion component attaching and detaching apparatus 1 includes the raising and lowering mechanism 11 that raises and lowers the spool piece 32a by expansion and contraction of the plurality of fluid pressure cylinders 11a, and the pushing-up mechanism 14 that pushes up and holds the spool piece 32a at a height at which attachment of the spool piece 32a to the drive mechanism main unit 31 of the control rod drive mechanism 3 is possible, in a case in which the raising and lowering mechanism 11 is incapable of holding the spool piece 32a at the height at which attachment of the spool piece 32a to the drive mechanism main unit 31 of the control rod drive mechanism 3 is possible. The use method includes pushing up and holding the spool piece 32a by the pushing-up mechanism 14 at the height at which attachment of the spool piece 32a to the drive mechanism main unit 31 of the control rod drive mechanism 3 is possible, in a case in which the raising and lowering mechanism 11 is incapable of raising and holding the spool piece 32a at the height at which attachment of the spool piece 32a to the drive mechanism main unit 31 of the control rod drive mechanism 3 is possible in order to attach the spool piece 32a to the drive mechanism main unit 31. The use method also includes attaching the spool piece 32a to the drive mechanism main unit 31.

Due to this, even when a load exceeding the pushing-up capability of the fluid pressure cylinders 11a of the raising and lowering mechanism 11 is acting on the spool piece 32a, the spool piece 32a can be easily joined to the drive mechanism main unit 31 by the lower-portion component attaching and detaching apparatus 1.

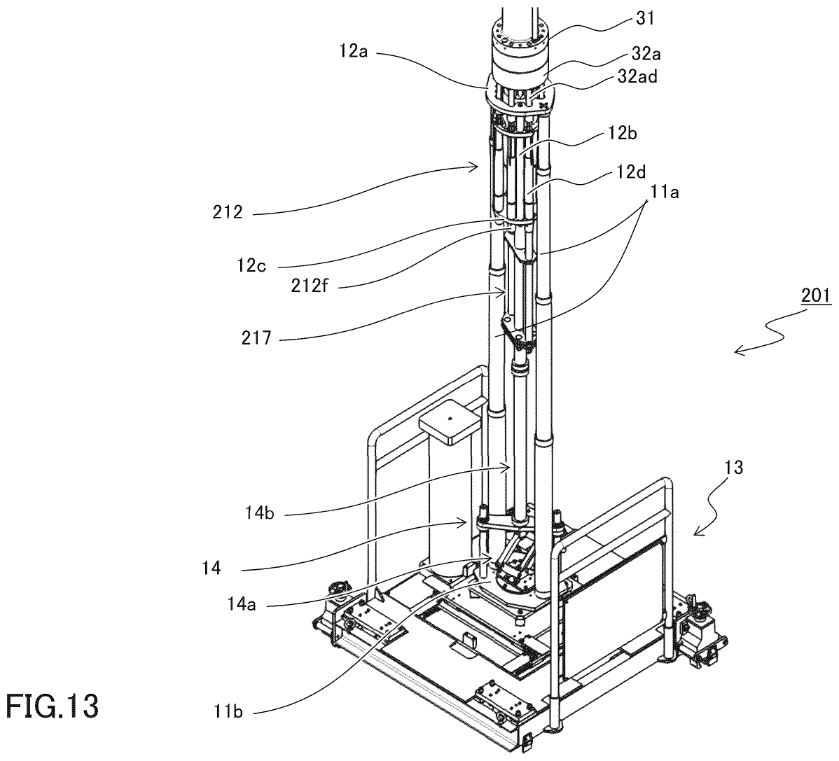

FIG. 13 is a schematic perspective view depicting a state in which, in a lower-portion component attaching and detaching apparatus 201 according to a second embodiment of the present invention, the raising and lowering mechanism 11 is incapable of holding the spool piece 32a at a height at which attachment of the spool piece 32a to the drive mechanism main unit 31 is possible, and the pushing-up mechanism 14 has pushed up the spool piece 32a to the height and holds the spool piece 32a.

Differences of the lower-portion component attaching and detaching apparatus 201 according to the present embodiment from the lower-portion component attaching and detaching apparatus 1 according to the first embodiment are as follows.

First, unlike the lower-portion component attaching and detaching apparatus 1 according to the first embodiment, the lower-portion component attaching and detaching apparatus 201 according to the present embodiment includes a torque wrench installation jig 217 that installs, under a spool piece holding jig 212, a torque wrench that manages the torque of fastening of the plurality of bolts 32ad into the plurality of bolt holes of the drive mechanism main unit 31.

Second, the lower-portion component attaching and detaching apparatus 1 according to the first embodiment includes the plurality of sockets 12f coupled to any of the plurality of bolt wrenches 12d, under the lower plate 12c of the spool piece holding jig 12. In contrast, the lower-portion component attaching and detaching apparatus 201 according to the present embodiment includes hexagonal wrenches 212f coupled to any of the plurality of bolt wrenches 12d, under the lower plate 12c of the spool piece holding jig 212.

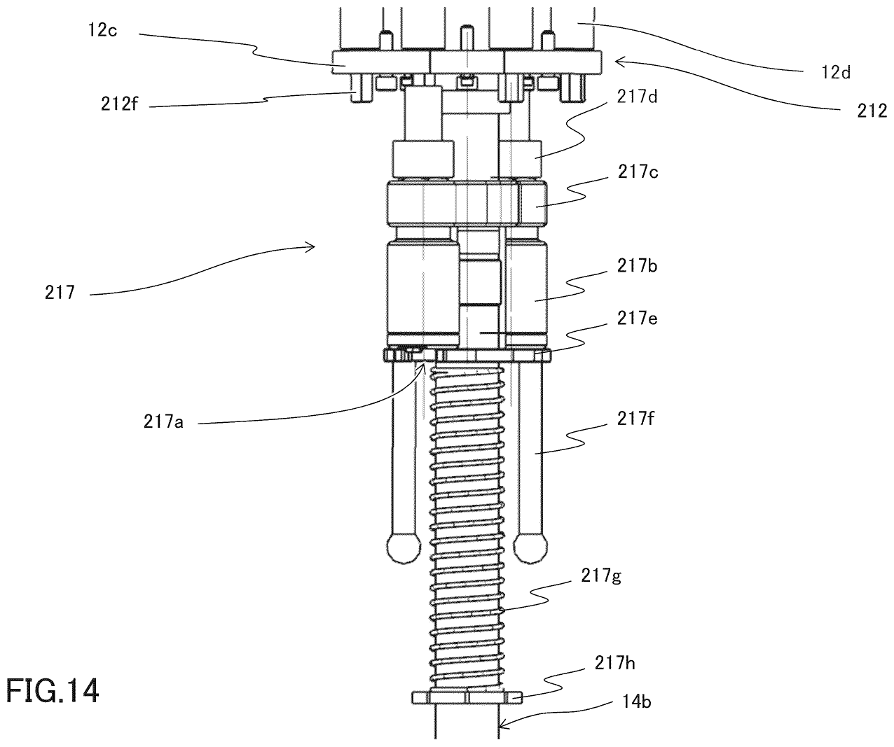

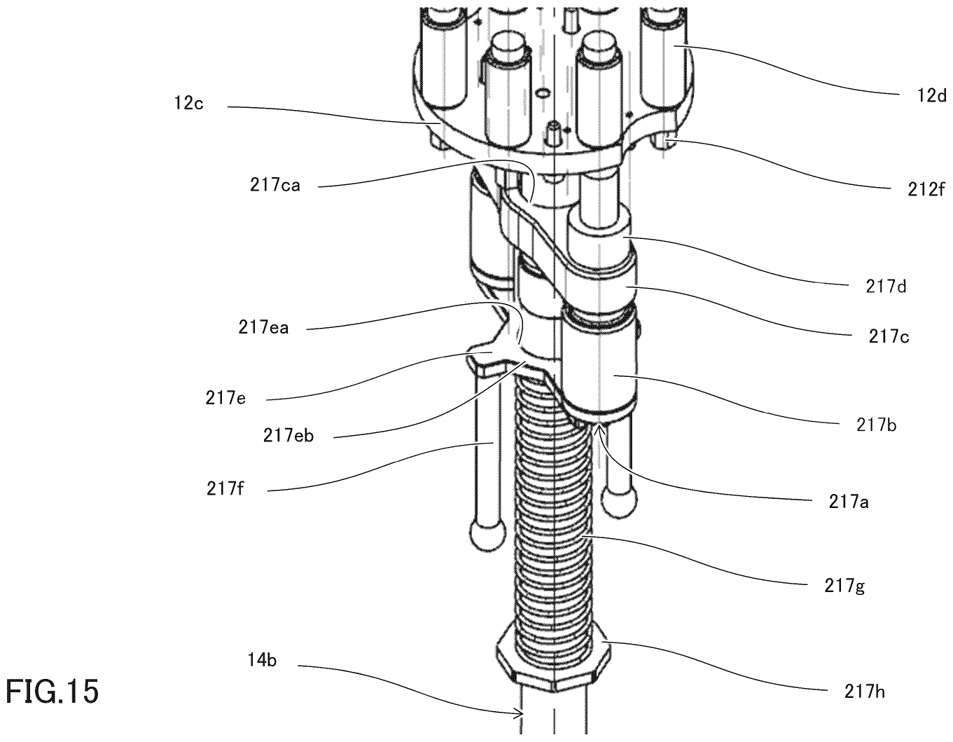

FIG. 14 is a side view of the torque wrench installation jig 217. FIG. 15 is a perspective view of the torque wrench installation jig 217.

It is preferable for the torque wrench installation jig 217 to include a wrench attachment portion 217a to which the torque wrench is attached, a booster wrench 217b, a booster wrench holding plate 217c, a socket 217d, a coupling plate 217e, a handle 217f, a spring 217g, and a stopper plate 217h.

The wrench attachment portion 217a is a portion having an attachment hole (not depicted) to which a square drive that is an output portion of the torque wrench set to input a specific torque value is attached, and is disposed under the spool piece holding jig 212. Thus, the torque wrench with the square drive attached to the attachment hole of the wrench attachment portion 217a is installed under the spool piece holding jig 212. The attachment hole of the wrench attachment portion 217a connects to a lower portion of the booster wrench 217b.

In a case of fastening/loosening the bolt 32ad in the lower-portion component attaching and detaching apparatus 1 of the first embodiment, a worker attaches a hexagonal socket to a square drive that is an output portion of a torque wrench, and inserts the tip of the hexagonal socket into the hexagonal hole of the socket 12f to execute the work. Thus, the worker is required to execute the fastening/loosening work of the bolt 32ad while supporting the torque wrench to prevent the tip of the hexagonal socket from separating from the hexagonal hole of the socket 12f.

In contrast, in the present embodiment, the square drive that is the output portion of the torque wrench is attached to the attachment hole of the wrench attachment portion 217a. Thus, the worker is not required to support the torque wrench to prevent the tip of the hexagonal socket from separating from the hexagonal hole of the socket 12f. Thus, the efficiency and the safety of the fastening/loosening work of the bolt 32ad can be improved.

The booster wrench 217b is a tool for amplifying an input force and outputting the amplified force. The torque wrench installation jig 217 of the present embodiment has two booster wrenches 217b. Therefore, the torque wrench installation jig 217 of the present embodiment has two wrench attachment portions 217a.

The specific torque value input from the torque wrench to the booster wrench 217b through the attachment hole of the wrench attachment portion 217a is amplified, for example, by a factor of 10 by the booster wrench 217b, and the amplified torque value is output to a bit portion (not depicted) at an upper portion of the booster wrench 217b.

The booster wrench holding plate 217c is a plate-shaped member that holds the booster wrenches 217b (the booster wrench holding plate 217c of the present embodiment holds upper portions of the booster wrenches 217b). A through-hole 217ca into which the prop portion 14b of the pushing-up mechanism 14 is inserted is defined at the center of the booster wrench holding plate 217c. Thus, the booster wrench holding plate 217c can rotate in the circumferential direction around the prop portion 14b and can move along the axial direction of the prop portion 14b. Further, the bit portion that is the output portion of the booster wrench 217b is exposed in a surface of the booster wrench holding plate 217c, and the socket 217d is attached to the bit portion.

The socket 217d is a tool for transmitting the output power of the booster wrench 217b to the bolt wrench 12d. The torque wrench installation jig 217 of the present embodiment has the same number of sockets 217d as the two booster wrenches 217b, that is, two sockets 217d. Lower portions of the sockets 217d are coupled to the bit portions of the booster wrenches 217b exposed from the surface of the booster wrench holding plate 217c.

In upper portions of the sockets 217d, holes that fit to outer circumferences of the hexagonal wrenches 212f disposed under the lower plate 12c of the spool piece holding jig 212 is defined. Therefore, the upper ends of the sockets 217d have a ring shape. Thus, damage given to the lower surface of the lower plate 12c when the upper end of the socket 217d abuts against the lower surface of the lower plate 12c can be suppressed compared with damage given to the lower surface of the lower plate 12c when the upper end of the hexagonal wrench abuts against the lower surface of the lower plate 12c.

The tip of the hexagonal wrench 212f is inserted into the hole of the socket 217d. The hexagonal wrench 212f fits into the hole of the socket 217d, and rotates in the circumferential direction together with the socket 217d by rotation of the socket 217d in the circumferential direction. Moreover, due to the rotation of the hexagonal wrench 212f in the circumferential direction, the bolt wrench 12d coupled to the hexagonal wrench 212f rotates in the circumferential direction. Further, due to the rotation of the bolt wrench 12d in the circumferential direction, the hexagonal wrench 12da at the upper end of the bolt wrench 12d rotates. Moreover, due to the rotation of the hexagonal wrench 12da, the bolt 32ad having the head 32af with the hexagonal hole into which the tip of the hexagonal wrench 12da is inserted rotates, and is fastened/loosened into/from the bolt hole of the drive mechanism main unit 31.

Therefore, the output torque output to the bit portion at the upper portion of the booster wrench 217b is substantially equal to the torque of fastening of the plurality of bolts 32ad into the bolt holes of the drive mechanism main unit 31. Thus, the torque resulting from inputting from the torque wrench and amplification by the booster wrench 217b is substantially equal to the torque of fastening of the plurality of bolts 32ad into the bolt holes of the drive mechanism main unit 31. Therefore, the specific torque value input from the torque wrench to the booster wrench 217b can be set to a small value.

The distance between the center axis of the through-hole 217ca into which the prop portion 14b is inserted at the center of the booster wrench holding plate 217c and the center axis of the hole in the upper portion of the socket 217d attached to the bit portion of the booster wrench 217b is substantially equal to the distance between the center axis of the prop portion 14b attached to the lower surface of the lower plate 12c of the spool piece holding jig 212 and the center axis of the hexagonal wrench 212f. This makes it possible to rotate the booster wrench holding plate 217c in the circumferential direction around the prop portion 14b and attach the socket 217d to each of the plurality of hexagonal wrenches 212f. Thus, the efficiency of work can be improved.

It is preferable that the coupling plate 217e that couples the plurality of booster wrenches 217b be disposed at the lower ends of the booster wrenches 217b. Due to this, the plurality of booster wrenches 217b are sandwiched by the booster wrench holding plate 217c and the coupling plate 217e to be integrated, and are inhibited from coming off of the booster wrench holding plate 217c. Thus, the safety can be improved.

The coupling plate 217e is a plate material that joins to each of the lower ends of the plurality of booster wrenches 217b and couples the plurality of booster wrenches 217b. A through-hole 217ea into which the prop portion 14b is inserted is defined at the center of the coupling plate 217e. Further, the wrench attachment portions 217a are disposed in a lower surface of the coupling plate 217c.

Moreover, it is preferable that the coupling plate 217e be provided with the handle 217f for pulling down the torque wrench installation jig 217 and rotating the torque wrench installation jig 217 around the prop portion 14b. The handle 217f of the present embodiment is formed of two circular rods extending downward from the lower surface of the coupling plate 217c.

Further, it is preferable that the lower surface of the coupling plate 217e be in contact with a circular ring-shaped portion of the upper end of the spring 217g wound around the prop portion 14b. Thus, it is preferable that the inner diameter of the through-hole 217ea of the coupling plate 217e be larger than the outer diameter of the prop portion 14b and be smaller than the inner diameter of the spring 217g, and it is preferable that a ring-shaped portion 217cb around the through-hole 217ea be larger than the outer diameter of the spring 217g.

It is preferable that the spring 217g be a component for easily attaching the socket 217d detached from one hexagonal wrench 212f by pulling down the handle 217f to another hexagonal wrench 212f and be a coil spring wound around the prop portion 14b. It is preferable that the upper end of the spring 217g be in contact with the lower surface of the coupling plate 217e and that the lower end of the spring 217g be in contact with the stopper plate 217h.

It is preferable that the position of the lower end of the spring 217g be defined by the stopper plate 217h such that the upper ends of the sockets 217d in the torque wrench installation jig 217 in a no-load state are in contact with the lower surface of the lower plate 12c. Moreover, it is preferable that the spring 217g easily contract through pulling-down of the handle 217f by a worker and be capable of easily pulling away the socket 217d from the hexagonal wrench 212f.

Due to this, the two sockets 217d attached to two hexagonal wrenches 212f can be attached to other two hexagonal wrenches 212f through pulling-down of the handle 217f and rotation in the circumferential direction around the prop portion 14b by a worker. Thus, the work efficiency can be improved.

The stopper plate 217h is a flange-shaped circular plate attached and fixed to the prop portion 14b. The fixing of the stopper plate 217h to the prop portion 14b prevents the torque wrench installation jig 217 from coming off of the lower-portion component attaching and detaching apparatus 201.

It is preferable to attach the torque wrench installation jig 217 to the upper rod material (in the present embodiment, rod material 14ba) among the plurality of rod materials forming the prop portion 14b when the upper rod material (in the present embodiment, rod material 14ba) is attached to the lower surface of the lower plate 12c of the spool piece holding jig 212.

As described above, the load applied from the control rod to the spool piece 32a includes the water head pressure of cooling water in the pressure vessel, the pressure being applied through the control rod. Thus, the load is significantly high compared with a load applied to the motor unit 32c or the motor bracket 32b. Thus, a high load is applied to the plurality of bolts 32ad that fix the spool piece 32a to the drive mechanism main unit 31, and there is a possibility of the occurrence of the following risks when the torque of fastening of the plurality of bolts 32ad into the plurality of bolt holes of the drive mechanism main unit 31 is weak.

For example, there is a possibility that the plurality of bolts 32ad gradually loosen and the spool piece 32a drops off due to vibrations that occur during operation of the control rod drive mechanism 3. Further, there is a possibility that a gap is generated at a seal portion between the spool piece 32a and the drive mechanism main unit 31 and leakage of the cooling water in the pressure vessel occurs. Moreover, there is a possibility that the attachment position of the spool piece 32a deviates and the control rod drive mechanism 3 becomes incapable of normal operation. Thus, the torque of fastening of the plurality of bolts 32ad into the plurality of bolt holes of the drive mechanism main unit 31 is required to be set strong.

Meanwhile, when excessive torque is applied to the bolts 32ad, there is a possibility that the bolt holes of the drive mechanism main unit 31 and the bolts 32ad become incapable of screwing to each other due to coming-off of the head portions of the bolts 32ad or breakage or wear of screw threads of at least either the plurality of bolt holes of the drive mechanism main unit 31 or the plurality of bolts 32ad. Therefore, in work of attaching/detaching the spool piece 32a to/from the drive mechanism main unit 31, the torque of fastening of the plurality of bolts 32ad into the plurality of bolt holes of the drive mechanism main unit 31 is required to be managed by using the torque wrench.

The lower-portion component attaching and detaching apparatus 201 according to the present embodiment includes the torque wrench installation jig 217 that installs, under the spool piece holding jig 212, the torque wrench that manages the torque of fastening of the plurality of bolts 32ad into the plurality of bolt holes of the drive mechanism main unit 31. This allows a worker to execute fastening/loosening work of the bolt 32d without supporting the torque wrench. Thus, the efficiency and the safety of the work can be improved.

Further, the torque wrench installation jig 217 includes the booster wrench 217b. Due to this, the specific torque value input by using the torque wrench can be set small, and thus effort of the worker can be reduced.

What is claimed is:

1. A lower-portion component attaching and detaching apparatus comprising:
a raising and lowering mechanism that raises and lowers a spool piece possibly included in a control rod drive mechanism that drives a control rod, by expansion and contraction of a plurality of fluid pressure cylinders; and
a pushing-up mechanism that pushes up and holds the spool piece at a height at which attachment of the spool piece to a main unit of the control rod drive mechanism is possible, in a case in which the raising and lowering mechanism is incapable of holding the spool piece at the height.

2. The lower-portion component attaching and detaching apparatus according to claim 1, wherein
the pushing-up mechanism includes a mechanical jack, and
a load receiving portion of the mechanical jack pushes up and holds the spool piece at the height.

3. The lower-portion component attaching and detaching apparatus according to claim 2, wherein
the pushing-up mechanism includes a support rod that supports a load of the spool piece over the load receiving portion of the mechanical jack, and
the support rod is formed by disposing a plurality of rod materials in series in an axial direction.

4. The lower-portion component attaching and detaching apparatus according to claim 1, wherein each of the plurality of fluid pressure cylinders is a multi-stage cylinder.

5. The lower-portion component attaching and detaching apparatus according to claim 1, wherein the fluid pressure cylinders are water pressure cylinders.

6. The lower-portion component attaching and detaching apparatus according to claim 1, further comprising:
a spool piece holding jig including
an upper plate that is joined to an upper portion of the raising and lowering mechanism and has a hole into which the spool piece is inserted,
a lower plate that is disposed under the upper plate, is joined to the upper plate with a plurality of rod-shaped members interposed therebetween, and supports the spool piece, and
a plurality of bolt wrenches that are attached to the lower plate rotatably in a circumferential direction and fasten and loosen each of a plurality of bolts that join the spool piece to the main unit of the control rod drive mechanism.

7. The lower-portion component attaching and detaching apparatus according to claim 6, further comprising:
a torque wrench installation jig that installs, under the spool piece holding jig, a torque wrench that manages torque of fastening of the plurality of bolts into a plurality of bolt holes of the main unit of the control rod drive mechanism.

8. The lower-portion component attaching and detaching apparatus according to claim 7, wherein the torque wrench installation jig includes a booster wrench.

9. A use method of a lower-portion component attaching and detaching apparatus for attaching and detaching a spool piece possibly included in a control rod drive mechanism that drives a control rod, to and from a main unit of the control rod drive mechanism,
the lower-portion component attaching and detaching apparatus including
a raising and lowering mechanism that raises and lowers the spool piece by expansion and contraction of a plurality of fluid pressure cylinders, and
a pushing-up mechanism that pushes up and holds the spool piece at a height at which attachment of the spool piece to the main unit of the control rod drive mechanism is possible, in a case in which the raising and lowering mechanism is incapable of holding the spool piece at the height,
the use method comprising:
pushing up and holding the spool piece at the height by the pushing-up mechanism in a case in which the raising and lowering mechanism is incapable of raising and holding the spool piece at the height in order to attach the spool piece to the main unit of the control rod drive mechanism; and
attaching the spool piece to the main unit of the control rod drive mechanism.
